(19) United States
(12) Patent Application Publication
(10) Pub. No.: US 2024/0177148 A1
(43) Pub. Date: May 30, 2024

(54) Non-custodial Wallet

(71) Applicant: MIRROR WORLD INC, Panama City (PA)

(72) Inventor: LE LI, Shenzhen (CN)

(21) Appl. No.: 17/994,789

(22) Filed: Nov. 28, 2022

(51) Int. Cl. G06Q 20/38; G06Q 20/40; H04L 9/06; H04L 9/14

(52) U.S. Cl. CPC G06Q 20/3829; G06Q 20/3825; G06Q 20/3827; G06Q 20/401; H04L 9/0643; H04L 9/14; G06Q 2220/00; H04L 2209/46

(57) ABSTRACT

The present invention discloses a method for generating keys and signatures based on multi-party calculation, and relates to the technical field of MPC the algorithm steps. The method for generating the keys and the signatures based on the multi-party calculation includes: generating public keys and sending a request for generating the public keys to the background of Party 0; performing collaborative calculation by Party 0 and Party 1 to obtain public keys through communication; and returning calculation results to a client by Party 0. By the multi-party calculation method, a wallet owner can sign by the keys, and whether a message is signed by the wallet owner through the public keys of a wallet can be verified through the public keys of the wallet. In the process, it is unnecessary to share sensitive information with other parties, and the problem that the keys are easy to lose is solved, thereby preventing properties in the wallet from being lost, and helping more non-technical users to use a blockchain wallet.

### TECHNICAL FIELD

The present invention relates to the technical field of MPC algorithms, and in particular to a method for generating keys and signatures based on multi-party calculation.

### BACKGROUND

A sub-field of secure multi-party calculation type cryptography aims to create a method for all parties to collaboratively calculate functions on inputs and retain these inputs, where MPC allows multiple parties to collaboratively generate keys and signatures without trusting each other. In the blockchain field, traditional wallets require owners to save private keys, where public keys can be analyzed to others, so that wallets can be verified.

In actual use, ordinary users need to keep keys to prevent disclosure of personal trouble information. However, if the keys are lost, it will lead to the disclosure of personal sensitive information, and may affect assets in the wallets.

### SUMMARY

### Technical Problem to be Solved

For the defects in the prior art, the present invention provides a method for generating keys and signatures based on multi-party calculation, which solves the problem that if the keys are lost, it will lead to disclosure of personal sensitive information, and may affect the assets in the wallets.

### Technical Solution

To achieve the above objective, the present invention is implemented by the following technical solution: a method for generating keys and signatures based on multi-party calculation includes the following steps:
the first step: generating public keys, including:
S1: sending a request for generating public keys to the background of Party 0,
S2: performing collaborative calculation by Party 0 and Party 1 to obtain public keys through communication, and
S3: returning calculation results to a client by Party 0; and
the second step: signing, including:
S1: sending a request for generating signatures to the background of Party 0,
S2: performing collaborative calculation by Party 0 and Party 1 to obtain signatures through communication, and
S3: returning calculation results to the client by Party 0.

Further, in the first step, the S2 of calculating the public keys includes:
S21: randomly selecting a random key from a field by each party and using SHA512 to perform Hash processing to obtain an extended private key; and
S22: aggregating generated keys to obtain aggregated public keys.

Further, in S21, Hash processing includes:
the first step: adding padding bits in an initial message to enable a length of the initial message to be equal to a value, where the value is 128 bits less than any multiple of 1024;
the second step: calculating the length of the message except the padding bits, and adding the message as a 128-bit block to the padding bits;
the third step: dividing input information into a plurality of blocks, a length of each block being 215 bits;
the fourth step: initializing link variables; and
the fifth step: converting the link variables as a single register, and updating the content of the register through an algorithm step.

Further, in the fifth step, the step of updating the content of the register specially includes:
S1: copying the link variables to conversion variables, and regarding the conversion variables as the single register for storing temporary intermediate results and final results;
S2: dividing a current 1024-bit block into 16 sub-blocks; and
S3: in each round of calculation, regarding the current 1024-bit block, the register and constants as inputs, and updating the content of the register through the algorithm step, with a total of 80 rounds.

Further, the link variables include A-H8 variables, and the conversion variables include a-h8 variables.

Further, the calculation formula of S21 is as follows:

sk(x∥prefix);
h=SHA512(sk);
private key x=h [0:32], wherein bits₂₅₅=0, bits₂₅₄=1, bits₂=bits₁=bits₀=0;
prefix=h [32:64];
public key A=xB, wherein B is a generator of a group;
the calculation formula of the step S22 is as follows:

public key=hash(Aapk₀,A₁)*A₀+hash(A₁,A₀)*A₁.

Further, in the second step, the S2 of calculating the signatures includes:
S21: signing and calculating signatures;
S22: performing verification through the generated signatures and the public keys.

Further, in S21, calculating the signatures specially includes the following steps:
the first step: randomly selecting a figure of 256 bits and calculating rᵢ by rᵢ=SHA512 (prefixᵢ∥M∥zᵢ), where prefixᵢ is the prefix of xᵢ and M is a message Hash;
calculating Rᵢ based on rᵢ:

Rᵢ=(rᵢ mod q)B, where B is the generator of the group;
calculating commitment tᵢ and sending the tᵢ to the other party, where tᵢ=hash (Rᵢ);
the second step: sending the Rᵢ to the other party, and when Rᵢ₋₁ is received, checking whether tᵢ₋₁ is equal to hash (R₁₋ᵢ); and
the third step: calculating the aggregated public keys apk;
calculating aᵢ=hash (Aᵢ, A₁₋ᵢ),
calculating R=R₀+R₁ and =hash (R, apk, M)ₖ,
calculating sᵢ=rᵢ+k*xᵢ*aᵢ mod q,
sending sᵢ to the other party and receiving sᵢ₋₁,
calculating signature s=sᵢ+sᵢ₋₁,
where the verification formula of S22 is 8sB==8R+8k*apk.

Further, after commitment check fails, signing is discontinued; and

after the signature check fails, output is continued and marked as invalid.

Further, communication in the first step and the second step adopt https communication.

### Beneficial Effects

The present invention has the following beneficial effects:

according to the method for generating the keys and the signatures based on multi-party calculation, by the multi-party calculation method, a wallet owner can sign by the keys, and whether a message is signed by the wallet owner through the public keys of a wallet can be verified. In the process, it is unnecessary to share sensitive information with other parties, and the problem that the keys are easy to lose is solved, thereby preventing properties in the wallet from being lost, and helping more non-technical users to use a blockchain wallet.

Certainly, it is unnecessary to achieve all the advantages described above at the same time to implement any product of the present invention.

### BRIEF DESCRIPTION OF THE DRAWINGS

FIG. 1 is a flow chart of a public key generating method according to the present invention; and

FIG. 2 is a flow chart of a signature generating method according to the present invention.

### DETAILED DESCRIPTION OF THE EMBODIMENTS

The technical solutions in the embodiments of the present invention are described below clearly with reference to the accompanying drawings in the embodiments of the present invention. Apparently, the described embodiments are a part, but not all the embodiments of the present invention. All other embodiments obtained by a person of ordinary skilled in the art based on the embodiments of the present invention without inventive efforts fall within the scope of protection of the present invention.

In the description of the present invention, it should be understood that orientation or position relationships indicated by terms such as “opening”, “upper”, “lower”, “thickness”, “top”, “middle”, “length”, “in” and “around” are just used to facilitate description of the present invention and simplify the description, but not to indicate or imply that the mentioned components or elements must have a specific orientation and must be established and operated in a specific orientation, and thus, these terms cannot be understood as a limitation to the present invention.

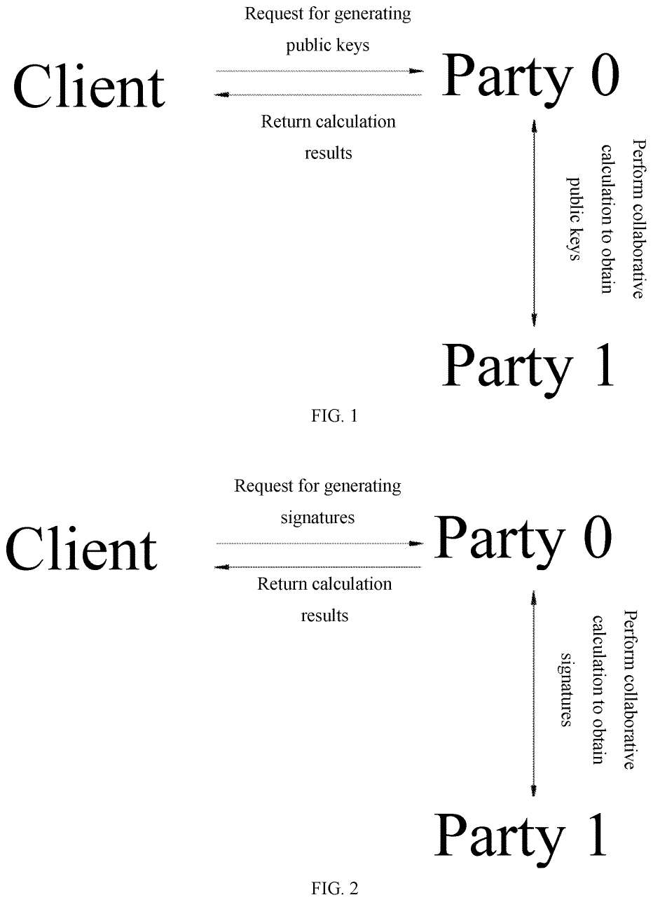

Please refer to FIG. 1 to FIG. 2, the embodiments of the present invention provide a technical solution: a method for generating keys and signatures based on multi-party calculation includes the following steps:
the first step: public keys are generated, including:
S1: a request for generating public keys is sent to the background of Party 0,
S2: Party 0 and Party 1 perform collaborative calculation to obtain public keys through communication, and
S3: Party 0 returns calculation results to a client; and
the second step: signing is performed, including:
S1: a request for generating signatures is sent to the background of Party 0,
S2: Party 0 and Party 1 perform collaborative calculation to obtain signatures through communication, and
S3: Party 0 returns calculation results to a client; and

In the first step, the S2 of calculating the public keys includes:
S21: a random key is randomly selected from a field by each party and SHA512 is used to perform Hash processing to obtain an extended private key; and
S22: the generated keys are aggregated to obtain aggregated public keys.

Specially, in S21, Hash processing includes:
the first step: padding bits are added in an initial message to enable a length of the initial message to be equal to a value, where the value is 128 bits less than any multiple of 1024;
the second step: the length of the message except the padding bits is calculated, and the message as a 128-bit block is added to the padding bits;
the third step: input information is divided into a plurality of blocks, where a length of each block is 215 bits;
the fourth step: link variables are initialized; and
the fifth step: the link variables are converted as a single register, and the content of the register is updated through an algorithm.

In the fifth step, the step of updating the content of the register specially includes:
S1: the link variables are copied to conversion variables, and the conversion variables are regarded as the single register for storing temporary intermediate results and final results;
S2: a current 1024-bit block is divided into 16 sub-blocks; and
S3: in each round of calculation, the current 1024-bit block, the register and constants are regarded as inputs, and the content of the register is updated through the algorithm step, with a total of 80 rounds.

The link variables include A-H8 variables, and the conversion variables include a-h8 variables.

In the embodiments, the client sends a request for “generating public keys” to the background of Party 0 through the https request, and then Party 0 and Party 1 communicate through https and perform collaborative calculation to obtain the public keys. The specific calculation step includes: each party selects a random key from a field, uses SHA512 to perform Hash processing to obtain an extended private key, and aggregates the generated keys to obtain aggregated public keys.

Hash processing specially includes: padding bits are added in an initial message to enable a length of the initial message to be equal to a value, where the value is 128 bits less than any multiple of 1024. The length of the message except the padding bits is calculated, and the message as a 128-bit block is added to the padding bits, so that the length of the message is exactly a multiple of 128. Then, input information is divided into a plurality of blocks, where the length of each block is 215 bits, and the blocks are inputs of message abstract processing logic.

The 8 link variables A-H are initialized, where in order to generate a 512-bit message abstract in SHA512, 8 link variables are needed, each link variable contains 64 bits, and then the blocks are processed. Firstly, the link variables A-H are copied into variables a-h, where variables a-h are regarded as a single register to store temporary intermediate results and final results. Then, the current 1024-bit block is divided into 16 sub-blocks, the current 1024-bit block, the register and constants are regarded as inputs, and the content of the register is updated through the SHA512 algorithm step, with a total of 80 rounds.

Specially, the calculation formula of the step S21 is as follows:

sk(x∥prefix);
h=SHA512 (sk);
private key x=h [0:32], where bits₂₅₅=0, bits₂₅₄=1, bits₂=bits₁=bits₀=0;
prefix=h [32:64]; and
public key A=xB, where B is a generator of a group.

The calculation formula of the step S22 is as follows:

public key=hash(Aapk₀,A₁)*A₀+hash(A₁,A₀)*A₁.

In the embodiments, the public keys can be calculated by the above formula. In the process, the owner does not need to share sensitive information and does not need to keep the keys.

Specially, in the second step, the S2 of calculating signatures includes:
S21: signing is performed and signatures are calculated; and
S22: verification is performed through the generated signatures and the public keys.

The S21 of calculating signatures specially includes the following steps:
the first step: a figure of 256 bits are randomly selected and rᵢ is calculated by rᵢ=SHA512 (prefixᵢ∥M∥zᵢ), where prefixᵢ is the prefix of xᵢ and M is a message Hash;
Rᵢ is calculated based on rᵢ:

Rᵢ=(rᵢ mod q)B, wherein B is the generator of the group;
commitment tᵢ is calculated and the tᵢ is sent to the other party, where tᵢ=hash (Rᵢ);
the second step: the Rᵢ is sent to the other party, and when Rᵢ₋₁ is received, whether tᵢ₋₁ is equal to hash (R₁₋ᵢ) is detected; and
the third step: the aggregated public keys apk are calculated,
aᵢ=hash (Aᵢ, A₁₋ᵢ) is calculated,
R=R₀+R₁ and =hash (R, apk, M)ₖ are calculated,
sᵢ=rᵢ+k*xᵢ*aᵢ mod q is calculated,
sᵢ is sent to the other party and sᵢ₋₁ is received,
signature s=sᵢ+sᵢ₋₁ is calculated,
where the verification formula of S22 is 8sB==8R+8k*apk.

After commitment check fails, signing is discontinued; and

after the signature check fails, output is continued and marked as invalid.

In the embodiment, based on the steps, the signatures can be obtained by calculation, and the signatures and the public keys are verified so as to verify whether the message is signed by the wallet owner through the public keys of the wallet.

Specially, communication in the first step and the second step adopt https communication.

In the embodiment, HTTPS is an HTTP channel aiming at security. Based on HTTP, the security of a transmission process is guaranteed through transmission encryption and identity authentication.

Multi-party calculation, that is MPC, allows multiple parties to collaboratively generate keys and signatures without trusting each other. In the blockchain field, each wallet has keys and public keys, wherein the public keys can be shared with others, but the keys need to be kept by the owner. The wallet owner can use the keys to sign. Others can verify whether the message is signed by the wallet owner through the public keys of the wallet. However, in order to prevent the wallet from losing the keys, the MPC the algorithm step can be used to collaboratively generate the keys and signatures through multi-party collaboration and

the client sends a request for “generating public keys” to the background of Party 0 through the https request, and then Party 0 and Party 1 communicate through https and perform collaborative calculation to obtain the public keys. The specific calculation step includes: each party selects a random key from a field, uses SHA512 to perform Hash processing to obtain an extended private key, and aggregates the generated keys to obtain aggregated public keys.

Hash processing specially includes: padding bits are added in an initial message to enable the length of the initial message to be equal to a value, where the value is 128 bits less than any multiple of 1024; the length of the message except the padding bits is calculated, and the message as a 128-bit block is added to the padding bits, so that the length of the message is exactly a multiple of 128; then, input information is divided into a plurality of blocks, where the length of each block is 215 bits, and the blocks are inputs to message abstract processing logic; and

the 8 link variables A-H are initialized, where in order to generate a 512-bit message abstract in SHA512, 8 link variables are needed, each link variable contains 64 bits, and then the blocks are processed. Firstly, the link variables A-H are copied into variables a-h, where variables a-h are regarded as a single register to store temporary intermediate results and final results; then, the current 1024-bit block is divided into 16 sub-blocks, the current 1024-bit block, and the register and constants are regarded as inputs, the content of the register is updated through the SHA512 algorithm step, with a total of 80 rounds.

Specially, the calculation formula is as follows:

sk(x∥prefix);
h=SHA512 (sk);
private key x=h [0:32], where bits₂₅₅=0, bits₂₅₄=1, bits₂=bits₁=bits₀=0;
prefix=h [32:64]; and
public keys A=xB, where B is a generator of a group; and

Then, the public keys are aggregated through public key=hash (Aapk0, A1)*A0+hash (A1, A0)*A1 to obtain the public keys, and the generated public keys are returned to the client through https communication.

After the public keys are generated, the signature link is entered, and the generated signatures and the public keys are verified:
firstly, the client sends a request for “generating signatures” to the background of Party 0 through the https request, and then Party 0 and Party 1 communicate through https and perform collaborative calculation to obtain the signatures. The specific calculation step includes: a figure of 256 bits are randomly selected and rᵢ is calculated by rᵢ=SHA512 (prefixᵢ∥M∥zᵢ), where prefixᵢ is the prefix of xᵢ and M is a message Hash; Rᵢ is calculated based on rᵢ, where the calculation formula is Rᵢ=(rᵢ mod q)B, where B is the generator of the group; commitment tᵢ is calculated and the tᵢ is sent to the other party, where tᵢ=hash (Rᵢ);
the Rᵢ obtained by calculation is sent to the other party, and when Rᵢ₋₁ is received, whether tᵢ₋₁ is equal to hash (R₁₋ᵢ) is checked; then, the aggregated public keys apk are calculated, and aᵢ, R, and sᵢ are calculated sequentially according to the following formula:

aᵢ=hash(Aᵢ,A₁₋ᵢ);

R=R₀+R₁ and=hash(R,apk,M)ₖ;

sᵢ=rᵢ+k*xᵢ*aᵢ mod q;
the calculated sᵢ is sent to the other party, sᵢ₋₁ is received, and the signatures s=sᵢ+sᵢ₋₁ are finally calculated;
verification is performed after the calculation signatures are obtained, where the verification formula is 8sB==8R+8k*apk.

In the process, after commitment check fails, signing is discontinued, so that the signatures cannot be generated. After the signature check fails, output is continued, but the output results are marked as invalid.

Based on the steps, the public keys and the signatures can be generated, and verification is performed, so that users do not need to keep the keys, and the public keys and the signatures are generated by multi-party calculation; and each party does not need to share sensitive information, so as to prevent the user from writing the private keys and causing disclosure of assets, and also help more non-technical users to use the blockchain wallet.

It should be noted that in this specification, relational terms such as first and second are only used to differentiate one entity or operation from another entity or operation, and do not necessarily require or imply that any actual relation or sequence exists between these entities or operations. Besides, the terms “comprise”, “include” or any other variants thereof are intended to cover non-exclusive inclusion, so that a process, method, article or device including a series of elements not only includes those elements, but also includes other elements not explicitly listed, or also includes elements inherent to such process, method, article or device.

The preferred embodiments of the present invention disclosed above are only used to help explain the present invention. Not all details are described in detail in the preferable embodiments, and the present invention is not limited to specific implementations. Obviously,

many modifications and changes may be made based on content of this specification. The embodiments are selected and specifically described in the specification to better explain the principle and practical application of the present invention, so that those skilled in the art can better understand and use the present invention. The present invention is limited only by the claims and full scope and equivalents thereof.

1. A method for generating keys and signatures based on multi-party calculation, comprising the following steps:
the first step: generating public keys, comprising:
S1: sending a request for generating public keys to the background of Party 0,
S2: performing collaborative calculation by Party 0 and Party 1 to obtain public keys through communication, and
S3: returning calculation results to a client by Party 0; and
the second step: signing, comprising:
S1: sending a request for generating signatures to the background of Party 0,
S2: performing collaborative calculation by Party 0 and Party 1 to obtain signatures through communication, and
S3: returning calculation results to the client by Party 0.

2. The method for generating the keys and the signatures based on the multi-party calculation according to claim 1, wherein in the first step, the S2 of calculating the public keys comprises:
S21: randomly selecting a random key from a field by each party and using SHA512 to perform Hash processing to obtain an extended private key; and
S22: aggregating the generated keys to obtain aggregated public keys.

3. The method for generating the keys and the signatures based on the multi-party calculation according to claim 2, wherein in the S21, Hash processing comprises:
the first step: adding padding bits in an initial message to enable a length of the initial message to be equal to a value, the value being 128 bits less than any multiple of 1024;
the second step: calculating the length of the message except the padding bits, and adding the message as a 128-bit block to the padding bits;
the third step: dividing input information into a plurality of blocks, a length of each block being 215 bits;
the fourth step: initializing link variables; and
the fifth step: converting the link variables as a single register, and updating the content of the register through the algorithm step.

4. The method for generating the keys and the signatures based on the multi-party calculation according to claim 3, wherein in the fifth step, the step of updating the content of the register specially comprises:
S1: copying the link variables to conversion variables, and regarding the conversion variables as the single register for storing temporary intermediate results and final results;
S2: dividing a current 1024-bit block into 16 sub-blocks; and
S3: in each round of calculation, regarding the current 1024-bit block, the register and constants as inputs, and updating the content of the register through the algorithm step, with a total of 80 rounds.

5. The method for generating the keys and the signatures based on the multi-party calculation according to claim 4, wherein the link variables comprise A-H8 variables, and the conversion variables comprise a-h8 variables.

6. The method for generating the keys and the signatures based on the multi-party calculation according to claim 2, wherein in the S21, the calculation formula is as follows:
sk(x∥prefix);
h=SHA512 (sk);
private key x=h [0:32], bits₂₅₅=0, bits₂₅₄=1, bits₂=bits₁=bits₀=0;
prefix=h [32:64];
public key A=xB, B being a generator of a group; and
the calculation formula of the step S22 is as follows:
public key=hash(Aapk₀,A₁)*A₀+hash(A₁,A₀)*A₁.

7. The method for generating the keys and the signatures based on the multi-party calculation according to claim 1, wherein in the second step, the S2 of calculating the signatures comprises:
S21: signing and calculating signatures;
S22: performing verification through the generated signatures and the public keys.

8. The method for generating the keys and the signatures based on the multi-party calculation according to claim 7, wherein the S21 of calculating the signatures specially comprises the following steps:
the first step: randomly selecting a figure of 256 bits and calculating rᵢ by rᵢ=SHA512 (prefixᵢ∥M∥zᵢ), prefixᵢ being the prefix of xᵢ and M being a message Hash;
calculating Rᵢ based on rᵢ:
Rᵢ=(rᵢ mod q) B, B being a generator of the group;
calculating commitment tᵢ and sending the tᵢ to the other party, tᵢ=hash (Rᵢ);
the second step: sending the Rᵢ to the other party, and when Rᵢ₋₁ is received, checking whether tᵢ₋₁ is equal to hash (R₁₋ᵢ);
the third step: calculating the aggregated public keys apk;
calculating aᵢ=hash (Aᵢ, A₁₋ᵢ);
calculating R=R₀+R₁ and =hash (R, apk, M)ₖ;
calculating sᵢ=rᵢ+k*xᵢ*aᵢ mod q;
sending sᵢ to the other party and receiving sᵢ₋₁;
calculating signature s=sᵢ+sᵢ₋₁,
the verification formula of the S22 being 8sB==8R+8k*apk.

9. The method for generating the keys and the signatures based on the multi-party calculation according to claim 8, wherein after commitment check fails, signing is discontinued; and
after the signature check fails, output is continued and marked as invalid.

10. The method for generating the keys and the signatures based on the multi-party calculation according to claim 1, wherein communication in the first step and the second step adopt https communication.
